(19) United States
(12) Patent Application Publication
(10) Pub. No.: US 2012/0326926 A1
(43) Pub. Date: Dec. 27, 2012

(54) HIGH SENSITIVITY GPS/GNSS RECEIVER

(75) Inventors: Wallace Earl Vander Velde, Winchester, MA (US); George Dimos, Lexington, MA (US); Jianhui Luo, Wayland, MA (US); Christopher J. Zarowski, Burlington, MA (US)

(73) Assignee: Mayflower Communications Company, Inc.

(21) Appl. No.: 13/494,144

(22) Filed: Jun. 12, 2012

Related U.S. Application Data
(60) Provisional application No. 61/571,312, filed on Jun. 24, 2011.

(51) Int. Cl. G01S 19/29; G01S 19/30

(52) U.S. Cl. 342/357.68; 342/357.69

(57) ABSTRACT

The GPS/GNSS receiver and method disclosed herein improves the GPS/GNSS receiver tracking sensitivity for detecting low signal-to-noise (SNR) GPS/GNSS signals through improved vector tracking, multibit correlation, improved extended range code-phase discrimination, and discrimination and navigation filter measurement via Probabilistic Data Association, individually or in combination. The solution is achieved without any external data aiding, such as from an inertial measurement unit, other wireless infrastructure source, or communication of GPS/GNSS satellite vehicle (SV) subframe data to the GPS/GNSS receiver over a data link.

This application claims the benefit of U.S. Provisional Application No. 61/571,312 filed on Jun. 24, 2011.

The present invention was made with U.S. Government support under Contract No. HM1582-09-C-0012 awarded by the National Geo-Spatial Intelligence Agency. The U.S. Government has certain rights to this invention.

### FIELD OF THE INVENTION

This invention relates to Global Positioning System and other Global Navigation Satellite System (GPS/GNSS) receivers. More particularly, the present invention is in the technical field of GPS/GNSS satellite signal tracking using a GPS/GNSS receiver. More particularly, the present invention is in the technical field of reliable, high sensitivity GPS/GNSS signal tracking of low signal-to-noise ratio (SNR) GPS/GNSS signals using a GPS/GNSS receiver.

### BACKGROUND OF THE INVENTION

The tracking of GPS/GNSS signals (i.e. GPS or other GNSS signals, hereinafter commonly referred to as “GPS signals”) using a GPS/GNSS receiver (i.e. GPS or other GNSS receiver, hereinafter commonly referred to as “GPS receiver”) typically involves the use of separate, fixed parameter (e.g., gain, bandwidth, and damping ratio) digital loop filters for the carrier and code tracking loops of each GPS/GNSS (i.e GPS or other GNSS, hereinafter commonly referred to as “GPS”) satellite (hereinafter referred to as “SV”) being tracked. In this specification and in the claims herein, the term “GPS” is substituted for GPS/GNSS, i.e. the term GPS should be read and understood as meaning any GNSS system, including but not limited to the Global Positioning System.

The traditional approach fails to fully exploit any useful correlations between the GPS signals in the tracking channels. Also, data bit modulation in the received signal limits the duration of coherent integration during code-tracking to avoid local replica code-correlation (accumulate-and-sum, or “integration”) over a bit-boundary. For example, since the Global Positioning System data bit time is 20 ms, the coherent integration of its signals is ordinarily limited to this 20 ms period, hence limiting the receiver processing gain.

Assisted-GPS (A-GPS), which involves the use of the GPS receiver in conjunction with a data communications network, allows data-aiding of the GPS receiver by such network. This way, for example, the GPS receiver “knows” the data bits, and can remove them for obtaining coherent integration periods longer than the data bit time. Obtaining coherent integration periods longer than the data bit time is only possible, however, where the receiver is aided by an external source, such as a data communication network; otherwise a stand-alone GPS receiver operating without any external data aiding is limited to coherent integration periods corresponding to the data bit time.

Also, the traditional choice of a fixed code-phase discriminator characteristic, often based on early, prompt and late code tracking channels, further limits the code-tracking reliability of low signal-to-noise ratio (SNR) GPS signals.

It is desirable to overcome these limitations cost-effectively as far as possible to improve the signal sensitivity of GPS receivers through innovative modifications to GPS receiver design. Improvement in GPS receiver signal sensitivity is needed to overcome the degradation in satellite signal power (which results in low SNR) experienced in urban, dense foliage, and indoor environments.

### SUMMARY OF THE INVENTION

A High Sensitivity GPS Receiver (HSGR) and method capable of tracking low signal-to-noise ratio (SNR) GPS signals, e.g. carrier-to-noise ratios (CNRs) of 16 to 20 dB-Hz or lower, is disclosed and claimed. Besides navigation filter measurement using Probabilistic Data Association (PDA) and/or improved extended range code-phase discrimination (XRD), its embodiments include improved vector tracking (VT) and multibit (Mbit) correlation, individually or in combination. The solution herein is achieved without any external data aiding, such as from an inertial measurement unit (IMU), other wireless infrastructure source, or communication of GPS satellite (SV) subframe data to the GPS receiver over a data link.

In one embodiment, the PDA determines the weights applied to the measurement updates in the navigation filter, thereby guarding against the use of spurious measurements and stabilizing the navigation solution under noisy conditions.

In one embodiment, the HSGR achieves improved GPS tracking sensitivity in part through the effect of vector tracking, wherein the PDA-augmented navigation filter state, conventional tracking loop filter information, and satellite ephemeris information from all the tracked satellites are combined to form the carrier and code Digital Controlled Oscillator (DCO) commands for exploiting the correlations between the tracked satellite signals. The correlation between the satellite signals originates from that part of the relative motion between the different tracked satellites and the GPS receiver that is due to the receiver's motion alone. Vector tracking (VT) allows the HSGR to track all the satellites cooperatively. The state information derived from all such satellites is used to assist any distressed (i.e. low SNR) satellites to maintain track where they may not be able to independently.

In one embodiment, Multibit (Mbit) correlation permits the dynamic estimation of the data bits and their subsequent removal to increase the effective code integration time during code tracking, leading to an increase in the effective post-correlation signal-to-noise ratio (SNR).

Also, in one embodiment, receivers which make available more than just the early, prompt, and late code correlator signals, the extended range code-phase discrimination (XRD) of the present invention prevents the divergence of the code-tracking process at even lower SNRs than is possible with either the VT or Mbit methods acting alone. However, the navigation error can be large when using XRD alone in comparison with using either or both VT and MBit. Improvements result when XRD is used in conjunction with one or both of these techniques.

The present invention does not allow the use of XRD if the underlying code-tracking hardware does not permit the use of more than three correlators in the tracking channel. In fact, depending on the available hardware and software resources and the desired tracking sensitivity performance, different embodiments of the invention become available. For example, the VT and Mbit methods may be used individually or together, or in combination with PDA-assisted navigation and/or XRD, to achieve the principal object of the invention, namely reliable GPS receiver tracking of low signal-to-noise ratio (SNR) GPS signals.

The features and advantages of the present invention are better understood when considered in conjunction with the accompanying drawings. The drawings are primarily for illustration and must not be construed as limiting. Other embodiments of the present invention apparent to those of ordinary skill in the art are within its scope. The scope of the invention is to be limited only by the claims, and not by the drawings or description herein.

### BRIEF DESCRIPTION OF THE DRAWINGS

FIG. 1 is an overview block diagram of the High Sensitivity GPS Receiver (HSGR) illustrating the major signal paths and emphasizing that the HSGR implements all tracking Digital Controlled Oscillator (DCO) commands formation through the use of both conventional loop filter information as well as navigation filter state and satellite ephemeris information.

FIG. 2 is a block diagram of the input signal from the digital down-converter (DDC) to the baseband carrier and code tracking stages showing the relationship between the carrier mixing and local replica code-correlation for one satellite tracking channel and the resulting post-correlation I and Q signals, as well as the fact that more than early, prompt and late channel correlators may be employed.

FIG. 3 is a block diagram of the multibit correlation (Mbit) subsystem indicating the estimation of data bits without the presence of an aiding network, and indicating that the estimated data bits are used to enhance the SNR of the post-correlation I and Q signals.

FIG. 4 is a block diagram of the carrier and code phase discriminator subsystems, including the option to employ extended range code-phase discrimination (XRD); the presence of conventional loop filters is also indicated.

FIG. 5 is a block diagram of the navigation filter block taken to be an extended Kalman filter (EKF) and indicating that navigation filter state information is combined with GPS satellite ephemeris information and conventional tracking loop filter outputs to arrive at the DCO commands for both carrier and code tracking loops which constitutes vector tracking (VT).

### DETAILED DESCRIPTION OF THE INVENTION

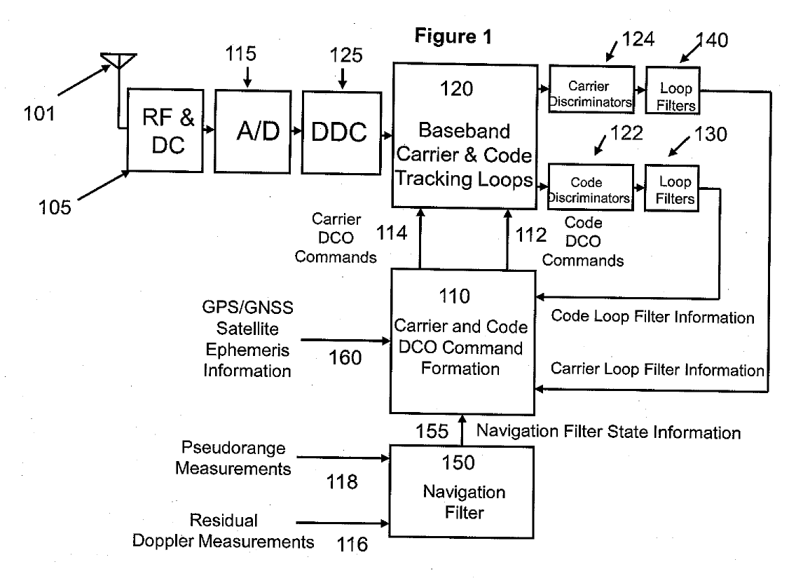

FIG. 1 presents an overview block diagram of the High Sensitivity GPS Receiver (HSGR). It shows a typical GPS receiver RF front end 105 for GPS signals received at antenna 101. The received signal is downconverted to an intermediate frequency and digitized using an Analog-to-Digital (A/D) converter 115. The digitized signal is processed with a Digital Down Converter (DDC) 125, whose output signal is provided at baseband to the Digital Signal Processor (DSP) 120 for code and carrier tracking. The Digital Controlled Oscillator (DCO) commands 112 and 114 used in the DSP 120 for code and carrier tracking, respectively, are derived 110 using information from the conventional code loop filter 130 and carrier loop filter 140, the navigation filter state 155 output by the navigation filter 150, and the satellite ephemeris data 160 received by the HGSR from the satellite (SV).

A. Navigation Filter State Model and the Navigation Filter

The true HSGR navigation state (position, velocity, time state) vector is assumed to be defined by the eight-element, real-valued column vector

x(t)=[r^{T}(t)ν^{T}(t)δT(t)δƒ(t)]^{T} (1)

where t is continuous (analog) time;
the receiver clock bias scalar is δT(t) (e.g., meters);
the corresponding receiver clock drift scalar is δƒ(t) (e.g., meters/second
the sub-vector r(t)=[rₓ(t)r_{y}(t)r_{z}(t)]^{T} is the receiver Earth-centered/Earth-fixed (ECEF) position state (e.g., meters); and
the sub-vector ν(t)=[νₓ(t)ν_{y}(t)ν_{z}(t)]^{T} is the receiver ECEF velocity state (e.g., meters/second).

Although the state vector x(t) may be augmented as necessary to suit other purposes (e.g., inclusion of an acceleration state for higher dynamics applications), the current state definition, when combined with the outputs of the conventional loop filters 130, 140 and satellite ephemeris information 160, is sufficient to form the required tracking loop code and carrier DCO commands 112, 114.

The state model herein is common to conventional GPS receivers and the HSGR. An important consequence of this is that the Vector Tracking (VT) algorithm of the present invention, described below, is readily integrated into the conventional GPS receiver signal tracking systems.

The ECEF position of the Sₗ satellite (SV), where l=1, 2, . . . , N_{S} and N_{S} is the number of satellites, is denoted as r_{S}_{ₗ}(t)=[r_{S}_{ₗ}_{,x}(t)r_{S}_{ₗ}_{y}(t)r_{S}_{ₗ}_{,z}(t)]^{T}, following the notation similar to that of the receiver state in Equation (1). Likewise, the ECEF velocity of the SₗSV, where l=1, 2, . . . , N_{S}, is denoted as ν_{S}_{ₗ}(t)=[ν_{S}_{ₗ}_{,x}(t)ν_{S}_{ₗ}_{,y}(t)ν_{S}_{ₗ}_{,z}(t)]^{T}.

The line-of-sight (LOS) relative velocity between each of the Sₗ SVs and the receiver is then given by:

$${V}_{{ρ}_{l}} ( t ) = \frac{1}{‖ {\underline{r}}_{{S}_{l}} ( t ) - \underline{r} ( t ) ‖} {( {\underline{v}}_{{S}_{l}} ( t ) - \underline{v} ( t ) )}^{T} ( {\underline{r}}_{{S}_{l}} ( t ) - \underline{r} ( t ) ) \qquad ( 2 )$$

which determines the Doppler shift between the Sₗ satellite and the receiver due solely to the relative motion of the two entities.

The Doppler shift on the carrier at the receiver is:

$$Δ {ω}_{L} ( t ) = - \frac{{v}_{ρ} ( t )}{c} {ω}_{L} ,$$

where ω_{L} is the link frequency, and c is the speed of light. The LOS velocity is important in determining the vector tracking DCO commands for the carrier and code tracking loops, as further discussed below.

The navigation filter can only generate an estimate of the true navigation state. In the present invention, this filter is preferably an Extended Kalman Filter (EKF), whose estimate is assumed to be the corrected state vector generated by the EKF algorithm. It will be obvious to those of ordinary skill in the art that this state estimate may be produced by other means (e.g., without limitation, least-squares methods) and by other filters. All such other means and filters are within the scope of the invention herein.

The pseudocode representation of the EKF navigation algorithm is as follows:

$$\begin{matrix}{\underline{\hat{x}}}^{-} ( k ) = Φ ( {T}_{U} ) {\underline{\hat{x}}}^{+} ( k - 1 ) \\ {P}^{-} ( k ) = Φ ( {T}_{U} ) {P}^{+} ( k - 1 ) {Φ}^{T} ( {T}_{U} ) + N\end{matrix} \} Predictor \\ \begin{matrix}K ( k ) = {P}^{-} ( k ) {{\hat{H}}^{T} ( k ) [ \hat{H} ( k ) {P}^{-} ( k ) {\hat{H}}^{T} ( k ) + R ]}^{- 1} \\ {\hat{\underline{x}}}^{+} ( k ) = {\hat{\underline{x}}}^{-} ( k ) + K ( k ) [ \underline{m} ( k ) - \underline{m} ( {\underline{\hat{x}}}^{-} ( k ) ) ] \\ {P}^{+} ( k ) = [ {I}_{8 \times 8} - K ( k ) \hat{H} ( k ) ] {P}^{-} ( k )\end{matrix} \} Corrector \qquad ( 3 )$$

The various terms in Equation (3) are discussed below.

The predicted state in Equation 3 is denoted by \hat{x}⁻(k), and the corrected state is \hat{x}⁺(k); k is an index or a discrete scale of time. Similarly, the predicted and corrected state-error covariance matrices are respectively denoted as P⁻(k), and P⁺(k), while the Kalman gain matrix is denoted as K(k). I_{a×a} denotes the order of the “a” identity matrix. The process noise covariance matrix is N, and the measurement noise covariance matrix is R. The entries for N and R are chosen (i.e. the EKF is tuned) in standard ways familiar to those skilled in the art. The state transition matrix, denoted by Φ(T_{U}), where T_{U} is the update interval, conforms to the choice of model for the underlying motion.

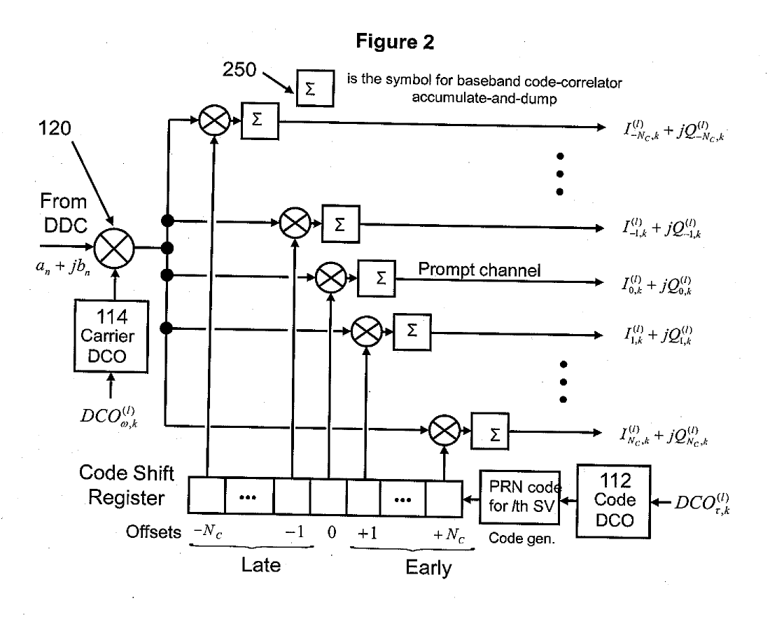

The update interval for the navigation filter, T_{U}, may not be smaller than Tₒ, the coherent integration time of the code-tracking loops prior to SNR enhancement, such as via Mbit correlation, i.e. T_{U}≧Tₒ. However, solely for ease of exposition, it is assumed that T_{U}=Tₒ in the accompanying figures and design equations (Equations 14 and 15 below). Also, the GPS signal input to every carrier and code satellite tracking loop 120 is taken to be the complex sequence denoted by aₙ+jbₙ (FIG. 2), which is output from the Digital Down Converter, DDC 125. The time step n in aₙ+jbₙ may be taken to be the Analog-to-Digital (A/D) converter 115 rate corresponding to time t=nT, where T is the sampling period.

The loop filters update at a much lower rate corresponding to the time period Tₒ, the length of the coherent integration time (i.e. the time to accumulate-and-dump 250 in FIG. 2). Due to the data bit duration in conventional (unassisted) GPS, Tₒ=20 ms for the Global Positioning System, but Tₒ is commonly not less than 1 ms. Since the data bit duration may be different from 20 ms in different GNSS systems, the statement here about data bit duration within the GPS system is, therefore, exemplary only and not limiting.

The estimated navigation state is:

\hat{x}⁺(k)=[(\hat{r}⁺(k))^{T}(\hat{ν}⁺(k))^{T}δ\hat{T}⁺(k)δ\hat{ƒ}⁺(k)]^{T}≡[\hat{r}ₖ^{T}\hat{ν}ₖ^{T}δ\hat{T}ₖδ\hat{ƒ}ₖ]^{T} (4)

Thus, Equation 4 provides the estimate of x(kT_{U}), the true navigation state at time t=kT_{U}.

The simplest choice of motion model is the uniform motion model:

$$Φ ( {T}_{U} ) = [ \begin{matrix}{I}_{3 \times 3} & {T}_{U} {I}_{3 \times 3} & 0 & 0 \\ 0 & {I}_{3 \times 3} & 0 & 0 \\ 0 & 0 & 1 & {T}_{U} \\ 0 & 0 & 0 & 1\end{matrix} ] \qquad ( 5 )$$

The uniform motion model is suitable for low dynamics GPS receiver applications (e.g., hand-held receiver for a pedestrian on the ground). The uniform motion model may be substituted with other models known in the art (e.g., sinusoidal motion, or state vector augmented with an acceleration state for high dynamics). Its mention here is only for illustration and not by way of limitation. All such alternative models known to those of ordinary skill in the art are within the scope of the present invention.

The column vector m(k) is the 2N_{S}-element vector of pseudorange 118 and residual Doppler 116 measurements (where N_{S} is the number of satellites in track). This latter type of measurement is new and innovative, and not found in any conventional GPS receiver. The residual Doppler measurement 116 represents the difference between the measured Doppler frequency and the value predicted by the navigation filter state estimate.

The elements of m(k) may be assumed to be organized in a column vector as follows:

$$\underline{m} ( k ) = {[ \underbrace{{\tilde{ρ}}_{k}^{( 1 )} {\tilde{ρ}}_{k}^{( 2 )} … {\tilde{ρ}}_{k}^{( {N}_{S} )}}_{pseudoranges} \underbrace{{\tilde{ω}}_{k}^{( 1 )} {\tilde{ω}}_{k}^{( 2 )} … {\tilde{ω}}_{k}^{( {N}_{S} )}}_{residual Dopplers} ]}^{T} \qquad ( 6 )$$

The vector m(\hat{x}⁻(k)) in Equation 3 represents predicted measurements, where the predictions depend on the EKF predicted state. Thus, the difference vector m(k)−m(\hat{x}⁻(k)) is the innovations vector for the EKF. The predicted pseudorange measurement to the lth satellite, Sₗ, is given by:

\hat{ρ}₍ₖ₎^{(l)}=∥\hat{r}⁻(k)−r_{S}_{ₗ}(k)∥+δ\hat{T}⁻(k) (7)

where r_{S}_{ₗ}(k), the ECEF satellite position at update time step k, is obtained via the ephemeris data for the satellites. Equation 7 provides the predicted value of \tilde{ρ}ₖ^{(l)}.

Under ideal conditions, the residual Doppler frequency \hat{ω}ₖ^{(l)} would be zero-valued, i.e. \hat{ω}ₖ=0, for all update time steps k and all satellites l. This would be true if the physical realization of the mathematical models were ideal. Since this is seldom the case, the residual Doppler measurements play an important role in improving the filter state model, as discussed below.

The matrix H(k) is the measurements sensitivity matrix. The general form of this matrix is the following:

$$H ( k ) = [ \begin{matrix}{\underline{h}}_{{ρ}_{1}}^{T} ( k ) \\ ⋮ \\ {\underline{h}}_{{ρ}_{{N}_{S}}}^{T} ( k ) \\ \\ {\underline{h}}_{{ω}_{1}}^{T} ( k ) \\ ⋮ \\ {\underline{h}}_{{ω}_{{N}_{S}}}^{T} ( k )\end{matrix} ] ∈ \qquad ( 8 )$$

where the rows of Equation 8 are as follows:

$${\underline{h}}_{{ρ}_{l}}^{T} ( k ) = [ \begin{matrix}\frac{{( \underline{r} ( k ) - {\underline{r}}_{{S}_{l}} ( k ) )}^{T}}{‖ \underline{r} ( k ) - {\underline{r}}_{{S}_{l}} ( k ) ‖} {\underline{0}}_{1 \times 3} 10 & 1 & 0\end{matrix} ] \\ {\underline{h}}_{{ω}_{l}}^{T} ( k ) = [ \begin{matrix}- {\frac{{( \underline{r} ( k ) - {\underline{r}}_{{S}_{l}} ( k ) )}^{T} ( \underline{v} ( k ) - {\underline{v}}_{{S}_{l}} ( k ) )}{{‖ \underline{r} ( k ) - {\underline{r}}_{{S}_{l}} ( k ) ‖}^{3}} [ \underline{r} ( k ) - {\underline{r}}_{{S}_{l}} ( k ) ]}^{T} + \frac{{( \underline{v} ( k ) - {\underline{v}}_{{S}_{l}} ( k ) )}^{T}}{‖ \underline{r} ( k ) - {\underline{r}}_{{S}_{l}} ( k ) ‖} \frac{{( \underline{r} ( k ) - {\underline{r}}_{{S}_{l}} ( k ) )}^{T}}{‖ \underline{r} ( k ) - {\underline{r}}_{{S}_{l}} ( k ) ‖} & 0 & - 1\end{matrix} ] \\ \qquad ( 9 )$$

The hatted form of H(k) in Equation 3, i.e. Ĥ(k), is intended to mean that Ĥ(k) is H(k) evaluated at the predicted state vector \hat{x}⁻(k). The ECEF satellite position r_{S}_{ₗ}(k) and ECEF satellite velocity ν_{S}_{ₗ}(k) are derived from the satellite ephemeris information. The sensitivities h_{ω}_{ₗ}(k) corresponding to residual Doppler measurements are the same as the sensitivities for standard Doppler measurements, as given in Equation 9.

B. Probabilistic Data Association (PDA) for Improved Navigation Solution

This section discusses the probabilistic data association (PDA) algorithm, which is used in the present invention for smoothing the navigation solution. (See, e.g., Y. Bar-shalom, T. Kirubarajan, X. Lin, “Probabilistic Data Association Techniques for Target Tracking with Applications to Sonar, Radar and EO Sensors,” IEEE Aerospace and Electronics Systems Magazine, Vol. 20, No. 8, pp. 37-56, 2003). Use of the PDA algorithm significantly improves the navigation filter performance by probabilistically fusing the measurements made using signals from the different satellites. In the VT of the present invention, PDA assigns greater weight to the measurements from satellites with strong GPS signals and less weight to those from satellites with weak signals, which usually exhibit larger pseudorange and Doppler errors. In this way, the state estimate is more robust with fewer outliers.

The PDA algorithm calculates in real-time the probability that each pseudorange and Doppler measurement is valid based on the available information. In this method, the Kalman filter state and covariance matrix updates are computed for each of the measurements using different satellites. The results are then combined using weights which are the probabilities that the measurements are valid. This PDA-enhanced filter is referred to as the PDA Filter (PDAF).

It is well known in the art that the processing of strong satellite signals (i.e. high SNRs) provides more stable and accurate velocity estimates essential for LOS velocity aiding in the VT tracking loops. However, when the satellite signals are weak (such as when a satellite is located close to the horizon or the receiver suffers shadow losses from its view being obstructed), it is still desired that the PDAF continue to process the measurements from the multiple satellites in a consistent manner, not requiring decisions at every update whether to use or ignore some measurements. The PDAF, consequently, assigns low weights to the results obtained from weak satellite signals, so that the calculated LOS velocity (based on the navigation solution) is more accurate and smooth, which stabilizes both the carrier and code tracking loops 120. Integration of the PDA with the Kalman filter, including the EKF, is known to those of ordinary skill in the art.

C. Tracking Error Process Model and Vector Tracking (VT) Concept

For implementing vector tracking (VT) in the present invention, the model below describes the time-evolution of the receiver tracking errors, and so includes (for the lth SV) carrier phase error sequence ψₖ^{(l)}, carrier frequency error sequence εₖ^{(l)}, and code phase error sequence τₖ^{(l)}:

$$\begin{matrix}{ψ}_{k}^{( l )} = {ψ}_{k - 1}^{( l )} - {T}_{o} ( {g}_{k} * {∇}_{ω , k}^{( l )} ) + {T}_{o} \frac{{ω}_{L}}{c} [ \begin{matrix}( {v}_{{ρ}_{l} , k - 1} - δ {f}_{k - 1} ) - \\ ( {\hat{v}}_{{ρ}_{l} , k - 1} - {\hat{δ f}}_{k - 1} )\end{matrix} ] ( radians ) & ( 10 ) \\ {ɛ}_{k}^{( l )} = \frac{1}{{T}_{o}} ( {ψ}_{k}^{( l )} - {ψ}_{k - 1}^{( l )} ) ( radians \text{/} seconds ) & ( 11 ) \\ {τ}_{k}^{( l )} = {τ}_{k - 1}^{( l )} - {T}_{o} ( {h}_{k} * {∇}_{τ , k}^{( l )} ) + \frac{{T}_{o}}{c} [ \begin{matrix}( {v}_{{ρ}_{l} , k - 1} - δ {f}_{k - 1} ) - \\ ( {\hat{v}}_{{ρ}_{l} , k - 1} - {\hat{δ f}}_{k - 1} )\end{matrix} ] ( seconds ) & ( 12 )\end{matrix}$$

The carrier phase error is ψₖ^{(l)}=φₖ^{(l)}−\hat{φ}ₖ^{(l)}, where φₖ^{(l)} is the true carrier phase of the lth SV and \hat{φ}ₖ^{(l)} the GPS receiver's estimate of this phase. The code phase error is τₖ^{(l)}=dₖ^{(l)}−\hat{d}ₖ^{(l)}, where dₖ^{(l)} is the true propagation delay (of the true code phase) from the lth satellite to the GPS receiver and \hat{d}ₖ^{(l)} is the receiver estimate of this delay (i.e. estimated code phase). A similar definition applies to the carrier frequency error, εₖ^{(l)}.

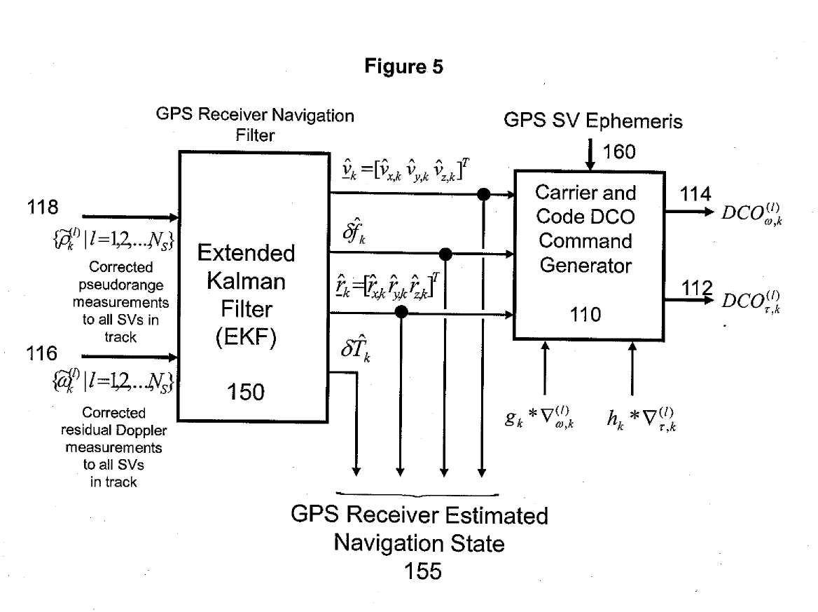

The above tracking error process model, Equations 10 through 12, apart from being useful in simulation modeling, is also used to infer, by the appropriate algebraic manipulations of Equations 10 through 12, the VT algorithm code and carrier DCO commands 112 and 114 (See, FIG. 2 and FIG. 5) and the dynamics of the residual Doppler measurements 116 that are input into the navigation filter 150 (FIG. 1 and FIG. 5). The detailed derivation, known to one skilled in the art, is not presented here; however, the required end results are described in detail below as these are sufficient to practically implement the VT algorithm in a real GPS receiver.

Equations 10 through 12 help explain a key aspect of the VT algorithm of the present invention. The terms containing ν_{ρ}_{ₗ}_{,k-1}−δƒₖ₋₁ in Equations 10 and 12 define the dynamic stress (comprising the variations in pseudorange and Doppler that drive the carrier tracking and code tracking loops) within a conventional GPS receiver tracking system. The VT algorithm herein uses the navigation filter state 155, which benefits from the measurements taken on all the satellites in track and the satellite ephemeris data 160 to estimate and subsequently remove the estimate of this stress from both the carrier and code tracking loops for each tracked satellite. Thus the tracking loops are only required to track the residual of the dynamic stress which remains after subtracting the filter's estimate of that quantity.

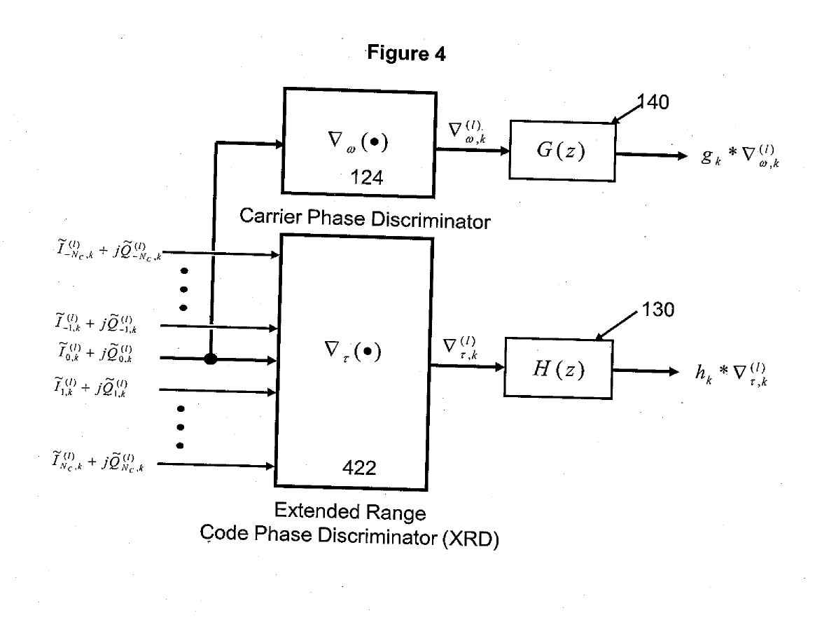

Equations 10 and 12 show that the tracking errors (hence DCO commands 112 and 114) continue to also depend on the outputs of the conventional loop filters 130 and 140. Specifically, ∇_{ω,k}^{(l)} is the carrier phase discriminator, e.g. 124, output for the lth satellite at time step k, and ∇_{τ,k}^{(l)} is the corresponding code phase discriminator, e.g. 422 in FIG. 4, output.

The Mbit correlation algorithm, discussed below, requires use of a digital phase locked loop (DPLL) for carrier phase discrimination. (The code phase discriminator too operates as a phase locked loop.) However, if only VT (and not Mbit correlation) is implemented, then the carrier discriminator may, optionally, be a digital frequency locked loop (DFLL) for frequency discrimination. The specific discriminator type is otherwise unimportant. The term gₖ*∇_{ω,k}^{(l)} denotes the discrete-time convolution of the carrier discriminator output with the unit sample response of the carrier loop filter G(z) 140 (FIGS. 1 and 4). This term gₖ*∇_{ω,k}^{(l)}, therefore, comprises the conventionally filtered carrier discriminator output.

Similarly, ∇_{τ,k}^{(l)} is the output of the code-phase discriminator 122 (FIG. 1) for code-tracking of the lth SV at time step k. The code-phase discriminator may, for VT, be of any conventional design. Or, it may be upgraded to an extended range code-phase discriminator (XRD) 422 as described below in Section F and shown in FIG. 4. Thus, the term hₖ*∇_{τ,k}^{(l)}, represents the discrete-time convolution of the code-phase discriminator output with the unit sample response of the code loop filter H(z) (FIGS. 1 and 4). This term hₖ*∇_{τ,k}^{(l)}, therefore, comprises the conventionally filtered code discriminator output.

If the loop filters are second order, then their z-domain transfer functions will be of the form:

$$\begin{matrix}G ( z ) = {g}_{1}^{′} + {g}_{2}^{′} \frac{1}{1 - {z}^{- 1}} , and & ( 13 a ) \\ H ( z ) = {h}_{1}^{′} + {h}_{2}^{′} \frac{1}{1 - {z}^{- 1}} & ( 13 b )\end{matrix}$$

where gₘ′ and hₘ′ (mε{1,2}) are the respective filter coefficients.

Standard methods known to persons of ordinary skill in the art exist to map desired loop filter bandwidths, damping ratios and gains to the filter coefficients gₘ′ and hₘ′ (mε{1,2}). Filters of order other than the second order may be used in the VT algorithm disclosed herein, and are within the scope of the present invention.

D. Vector Tracking (VT) Carrier and Code DCO Commands

By suitable manipulation of the carrier phase tracking error dynamic model of Equation 10, the carrier DCO command 114 for VT is determined as:

$${DCO}_{ω , k}^{( l )} = {T}_{o} ( {g}_{k} * {∇}_{ω , k}^{( l )} ) + {T}_{o} \frac{{ω}_{L}}{c} [ {\hat{v}}_{{ρ}_{l} , k - 1} - {\hat{δ f}}_{k - 1} ] \qquad ( 14 )$$

Similarly, by appropriate manipulation of Equation 12, the code DCO command 112 for VT is determined as:

$${DCO}_{τ , k}^{( l )} = {T}_{o} ( {h}_{k} * {∇}_{τ , k}^{( l )} ) + {T}_{o} \frac{1}{c} [ {\hat{v}}_{{ρ}_{l} , k - 1} - {\hat{δ f}}_{k - 1} ] \qquad ( 15 )$$

As stated before, these commands take into account conventional tracking loop filter information, navigation filter state, and satellite ephemeris information. The estimated dynamic stress terms in Equation 14 and in Equation 15 do not exist in conventional tracking loops and existing VT algorithms. The inclusion of the estimated dynamic stress terms in the formation of the loop filter DCO commands relieves a burden upon these otherwise conventional filters.

Won et al. (See, J.-H. Won, D. Dötterböck, B. Eissfeller, “Performance Comparison of Different Forms of Kalman Filter Approaches for a Vector-Based GNSS Signal Tracking Loop,” Navigation, 57(3), Fall 2010, pp. 185-199) summarize the benefits of different versions of Kalman filter-based VT relative to conventional tracking (CT). Four specific Kalman filter-based VT ‘Options’ are considered therein. Three of the options (Option 1 to Option 3) consider designs that work with a state vector containing tracking error states (i.e., variables such as ψₖ^{(l)}, εₖ^{(l)}, and τₖ^{(l)} in the tracking error process model update as in Equations 10-12 above). These designs necessitate the use of additional processing to provide updates of the code-phase and carrier-phase rates to obtain DCO commands, whereas such additional processing is not needed in the present HSGR VT design (Equations 14 and 15 above). Option 1, additionally, has a reasonably complex sensitivity matrix relationship between the post-correlation I-and-Q measurements and the error states, further complicating the VT implementation.

Option 4 in Won et al. makes use of a state vector that contains the code phase, carrier phase, carrier frequency and carrier frequency rate (See, Equation (23) in Won et al.). However, this leads to a design where optimal control theory (e.g., linear quadratic Gaussian) is needed to estimate a Kalman filter gain matrix, and the implementation complexity is increased relative to the present invention's HSGR VT design. Whereas, as noted in Won et al., some prior art VT designs force the navigation filtering to run at the same rate as the tracking filtering, the EKE-based navigation filter (Equation 3) in the present HSGR VT is permitted to run at a rate slower than that of the conventional loop filters (i.e. T_{U}≧Tₒ), reducing the overall computational burden in receiver implementation.

Thus, vector tracking (VT) yields well-known benefits in GPS navigation—especially in distressed signal conditions. The present invention's VT formulation offers advantages relative to known existing configurations in terms of relieving stress in signal tracking, reducing implementation complexity, and/or reducing the computational burden.

E. Residual Doppler Measurements Augmentation of the Navigation Filter

The residual Doppler signal for the lth satellite (SV) is defined to be the sequence

ωₖ^{(l)}=(ν_{ρ}_{ₗ}_{,k-1}−δƒₖ₋₁)−(\hat{ν}_{ρ}_{ₗ}_{,k-1}−δ\hat{ƒ}ₖ₋₁) (16)

Physically, this entity is the difference between the stress upon the carrier and code tracking loops due to the relative motion between the GPS receiver and the GPS satellites and the estimate of that stress. This entity can itself only be estimated in the receiver as specified below.

From the tracking error process model Equations 10-12 above, it can be shown that the residual Doppler measurement for the lth SV is given by the carrier loop filter output:

$${\tilde{ω}}_{k}^{( l )} = \frac{c}{{ω}_{L}} ( {g}_{k} * {∇}_{ω , k}^{( l )} ) \qquad ( 17 )$$

Note that the processing of the residual Doppler measurements by the navigation filter allows elimination of navigation bias error due to model mismatch as verified with laboratory testing of the VT algorithm of the present invention. It is in this respect that the residual Doppler measurements are important in the practical system implementation. Thus, Equation 17 provides the bottom N_{S} entries for the measurements vector of Equation 6.

F. Extended Range Code-Phase Discrimination (XRD)

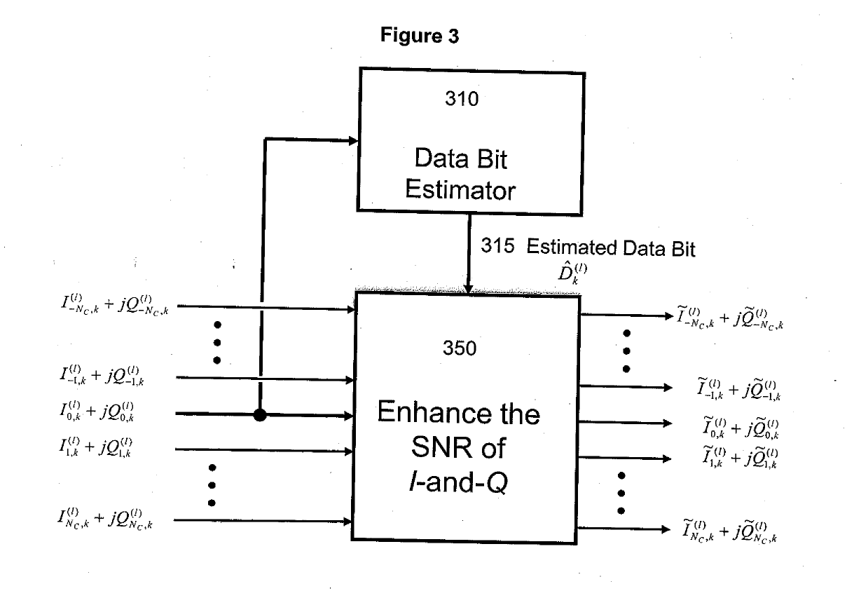

With the GPS receiver code correlation hardware allowing the use of multiple extended range correlators (i.e., providing more than just early, prompt, and late channels), the VT (FIG. 5) and/or Mbit (FIG. 3) algorithms can be optionally combined with extended range code phase discrimination (XRD) 422 for additional code-tracking sensitivity (FIG. 4).

The XRD algorithm herein is an improvement upon an earlier XRD algorithm derived using nonlinear estimation theory in T. N. Upadhyay et al., Advanced GPS/Inertial Integration Technology Program (ADGINT) (U), Technical Report AFWAL-TR-80-1148, The Charles Stark Draper Laboratory, Inc., vol. II, February 1981. From optimal analog nonlinear filtering theory, this report had concluded that the optimal code-phase discriminator characteristic curve has the form of the first derivative of a Gaussian pulse function of code phase error τ; specifically:

$${f}_{l} ( t ) = \frac{τ}{{σ}_{τ}^{( l )}} exp \{ - \frac{τ}{2 {( {σ}_{τ}^{( l )} )}^{2}} \} \qquad ( 18 )$$

where (σ_{τ}^{(l)})² is the variance of the code phase error (that is, code jitter) for the lth satellite.

Thus, (σ_{τ}^{(l)})² can be understood to be the variance of the code phase error sequence (in Equation 12) under steady-state conditions.

The stable operating point for code tracking corresponds to zero code phase error, i.e. τ=0. The curve of Equation 18 has extrema (local minimum/local maximum) at the points τ=±σ_{τ}^{(l)} so that the operating region for code tracking is the region between these points, i.e. code phase errors satisfying −σ_{τ}^{(l)}≦τ≦σ_{τ}^{(l)}. The slope of the curve of Equation 18 at τ=0 is 1/σ_{τ}^{(l)}.

As the code phase error increases, indicated by an increase in the jitter (σ_{τ}^{(l)})², the operating region increases in size while the discriminator gain, which is the slope of the code-phase discriminator about τ=0, diminishes. This stabilizes the code tracking, thereby preventing divergence of the receiver code phase error with decreasing GPS signal-to-noise ratio, SNR.

An approximation to the theoretically ideal code phase discriminator curve of Equation 18 may be physically realized according to FIG. 4 via the equation:

$${∇}_{τ , k}^{( l )} = {\sum }_{m = 1}^{{N}_{C}} {w}_{m}^{( l )} [ ( {( {\tilde{I}}_{m , k}^{( l )} )}^{2} + {( {\tilde{Q}}_{m , k}^{( l )} )}^{2} ) - ( {( {\tilde{I}}_{- m , k}^{( l )} )}^{2} + {( {\tilde{Q}}_{- m , k}^{( l )} )}^{2} ) ] \qquad ( 19 )$$

where N_{C} is the number of correlators on either side of the prompt correlator, and the correlator weights are given by

$${w}_{m}^{( l )} = {f}_{l} ( \frac{m}{2} ) \qquad ( 20 )$$

In this example realization of an approximation to Equation 18, the correlators are spaced ½-chip apart. Equation 20 assumes σ_{τ}^{(l)} is in units of chips, and the methods of estimating this entity are discussed below. The code discriminator functions, such as Equation 19, are implemented in software where the post-correlation I-and-Q signals that are input to the discriminators come from hardware, and thus the computation of Equation 20 is implemented in software. This particular method for computing correlator weights is illustrative, and there exist other algorithms to determine correlator weights, such as nonlinear least-squares curve-fitting algorithm, and within the scope of this disclosure. The notations used in Equation 19 imply the use of Mbit correlation for providing SNR-enhanced I-and-Q (in phase-and-quadrature) sequences as inputs to the XRD 422; however, this is not essential, and un-enhanced signals I_{m,k}^{(l)}+jQ_{m,k}^{(l)} (See, FIGS. 2 and 3) may be used instead.

Within the GPS receiver there is no provision for directly accessing code phase error sequences; hence, the variance of such errors (σ_{τ}^{(l)})² must be estimated, as noted above. A number of means of doing this can be found in the literature. An approach to estimating this jitter is to employ adaptive Kalman filtering (AKF), which involves augmenting the extended Kalman filter (EKF) pseudocode of Equation 3. A typical, classical reference in this field is R. K. Mehra, “On the Identification of Variances and Adaptive Kalman Filtering,” IEEE Trans. on Automatic Control, 15(2), April 1970; other relevant references are discussed below.

The measurement noise covariance matrix R has main diagonal elements, some of which correspond to the variances of pseudorange measurement noise and some to the variances of the residual Doppler measurement noise. The AKF augments the basic Kalman filtering algorithm for dynamically estimating R and implicitly estimating the variances σ_{ρ}_{ₗ}²=c²(σ_{τ}^{(l)})², thereby giving Equation 18 and permitting the desired XRD weights to be calculated in Equation 20. This approach to the estimation of R, and hence to the estimation of code phase jitter, is an improvement upon the method in T. N. Upadhyay cited above in that the algorithm in that report did not specify how to estimate such variances.

There are at least two known methods to estimate R in the framework of the AKF, the fading memory approach and the sliding window approach.

The fading memory approach is used in one embodiment as follows:

R*(k)=[m(k)−m(\hat{x}⁺(k))][m(k)−m(\hat{x}⁺(k))]^{T}−Ĥ(k)P⁺(k)Ĥ^{T}(k)

\hat{R}(k)=\hat{R}(k−1)+α_{R}[R*(k)−\hat{R}(k−1)] (21)

Here α_{R}>0 is the fading memory parameter, which is small and chosen by trial and error to tradeoff the steady-state estimation error performance versus rate of convergence; See, e.g., F. D. Busse, J. P. How, J. Simpson, “Demonstration of Adaptive Extended Kalman Filter for Low Earth Orbit Formation Estimation Using CDGPS,” Proc. ION GPS meeting, September 2002, Portland, Oreg., USA.

The alternative sliding window approach is used in another embodiment as follows:

$$\underline{v} ( k ) = \underline{m} ( k ) - \underline{m} ( {\underline{\hat{x}}}^{+} ( k ) ) \\ \hat{R} ( k ) = \frac{1}{W} {\sum }_{j = k - W + 1}^{k} \underline{v} ( j ) {\underline{v}}^{T} ( j ) + \hat{H} ( k ) {P}^{+} ( k ) {\hat{H}}^{T} ( k ) \qquad ( 22 )$$

The duration of the sliding window is determined by the positive integer W (which represents the duration of the window in units of the EKF update time interval); See, e.g., A. H. Mohamed, K. P. Schwarz, “Adaptive Kalman Filtering for INS/GPS,” J. of Geodesy, 173(4), 1999, pp. 193-203. In either of Equation 21 or Equation 22, the matrix \hat{R}(k) replaces R in Equation 3. The appropriately selected main diagonal elements of \hat{R}(k) yield the desired estimates of (σ_{τ}^{(l)})² over time for each satellite in track, via the simple relationship σ_{ρ}_{ₗ}²=c²(σ_{τ}^{(l)})².

G. Multibit Correlation Processing

Multibit (Mbit) correlation (FIG. 3) is used to enhance the signal-to-noise ratio (SNR) of the post-correlation I-and-Q signals, I_{m,k}^{(l)}+jQ_{m,k}^{(l)}, output from the code tracking correlators shown in FIG. 2. The SNR-enhanced I-and-Q sequences are denoted as Ĩ_{m,k}^{(l)}+j\tilde{Q}_{m,k}^{(l)}, which is the SNR-enhanced I-and-Q sequence for the lth SV at time step k and for correlator offset m. The SNR-enhanced I-and-Q signals are output at the same rate as the input post-correlation I-and-Q signals (e.g., Tₒ=20 ms). Thus, the SNR-enhanced I-and-Q signals can be handled by the subsequent carrier and code phase discrimination and filtering processes in the usual way.

The data bit estimator 310 of the present invention estimates the polarity (0 or 1) of multiple navigation data bits (e.g., 50 Hz in GPS) and provides this estimate 315 to the Multibit (Mbit) correlator 350 to integrate the IQ samples over the bit boundary (for example, more than 20 ms for the Global Positioning System) and thereby improve SNR.

There are presently two ways to enable GPS receivers to integrate IQ data over a bit boundary that are related to (but are also quite different from) the method herein. The first method uses assisted GPS (A-GPS). In A-GPS, the navigation data bits are real-time decoded and communicated to the GPS receiver by other wireless infrastructure, such as, but not limited to, cell phone or Wi-Fi. (See, e.g., Frank van Diggelen, A-GPS: Assisted GPS, GNSS, and SBA, Artech House, 2009.) The second method uses navigation data prediction based on the deterministic part of the navigation message (almanac and ephemeris). (See, e.g., M. V. Vorobiev, J. Ashjaee, Navigation Data Prediction for GPS and GLONASS Weak Signal Tracking, Topcon GPS May 2004; See also, U.S. Pat. No. 6,731,701.)

The disadvantage of the first method is that the GPS receiver is dependent on other wireless infrastructure for navigation aiding data. The disadvantage of the second method is that when the almanac or ephemeris data field is updated at any time, the navigation data prediction will fail.

The present invention's preferred data bit estimator 310 neither requires network assistance for the navigation data, nor depends on the navigation data structure. Instead, the data bit estimator 310 uses fast quadratic programming optimization to estimate data bits that maximize the output I-Q power and SNR enhancement.

### Multibits Optimization Problem Formulation

Under low SNR conditions, i.e. carrier-to-noise ratios (CNRs) of 16 to 20 dB-Hz or lower, the underlying assumption is that conventional data detection cannot be performed on the 20 ms samples. Given that the M complex correlation samples for a prompt satellite channel are Xₘ=I_{0,m}+jQ_{0,m} (for m=(n−1)M+1, . . . , nM), and these are independent and normally distributed, the optimal estimation approach for the M-bit long sequence of data bits (\hat{D}=±1) is the maximum likelihood estimation (MLE) method, which maximizes the output IQ power, i.e.:

$$OPTIMAL \hat{D} \text{:} f ( \hat{D} ) = {MAX}_{\hat{D}} {\vert {\sum }_{m} {\hat{D}}_{m} {I}_{0 , m} \vert}^{2} + {\vert {\sum }_{m} {\hat{D}}_{m} {Q}_{0 , m} \vert}^{2} \qquad ( 23 )$$

where Dₘ=±1 is the data modulated onto the IQ signal, and I_{0,m} and Q_{0,m} are the IQ correlation outputs (20 ms for Global Positioning System) for the bit m.

The brute-force method to solve the above optimization problem is through performing an exhaustive search of all possible bit combinations for the M-bit block. The exhaustive search algorithm searches all the possible data sequences \hat{D} over M-dimensional space to find the data sequence that has the maximum value of ƒ(D). Although this method will get an optimal solution, the complexity of this problem increases exponentially with increasing number of bits, M. Indeed, the method is impractical if M is too large (e.g. >20 Bits).

An alternative to the above exhaustive search approach that is more computationally efficient for large M is incorporated in the present invention as described below.

### Quadratic Programming

The original problem in Equation 23 can be mathematically reformulated as a member of a class of problems called Integer-constrained Quadratic Programming (IQP).

The original multibit optimization can be reorganized as follows:

$$Maximize \text{:} \begin{matrix}f ( D ) = {\vert {\sum }_{m} {D}_{m} {I}_{0 , m} \vert}^{2} + {\vert {\sum }_{m} {D}_{m} {Q}_{0 , m} \vert}^{2} \\ = {D}^{T} \cdot {I}^{T} \cdot I \cdot D + {D}^{T} \cdot {Q}^{T} \cdot Q \cdot D \\ = {D}^{T} [ {I}^{T} I + {Q}^{T} Q ] D \\ = {D}^{T} HD\end{matrix} \\ where H = {I}^{T} I + {Q}^{T} Q \\ subject to D ∈ C := \{ D \text{:} {D}_{i} ∈ \{ - 1 , 1 \} , i = 1 , 2 , … n \} \qquad ( 24 )$$

Here H is an M×M symmetric positive semi-definite matrix. The maximum rank of H is 2. The above problem is known to be NP hard (NP=non-deterministic polynomial time). (See e.g., K. Allemand, K. Fukuda, T. M. Liebling, E. Steiner, “A Polynomial Case of Unconstrained Zero-one Quadratic Optimization,” Mathematical Programming, 91(1), October 2001.) However, the above problem can be relaxed to a pure linear Quadratic programming (QP) problem due to the special property of the H matrix and the function ƒ(D).

The function ƒ(D) is a convex function since H is a positive semi-definite matrix. H is a semi-definite matrix since a possible solution with all zeros for vector D will make ƒ(D)=0. In this case, the quadratic program has a unique global maximum if there exists at least one vector x satisfying the constraints and ƒ(D) is bounded below on the feasible region (the set of all values of D that satisfy its constraints). Due to the fact that H is a symmetric positive semi-definite matrix, the optimal solution for the above problem is the same as that of its continuous relaxation defined by

Maximize: ƒ(D)=D^{T}HD

subject to DεC:={D:−1≦Dᵢ≦1, i=1,2, . . . ,n} (25)

The above maximization is a standard Quadratic programming (QP) problem. The QP programming, which is based on Equation 25, is certain to obtain the optimal solution since it will converge to the extreme points with user specified error tolerance. Then the optimal solution can be rounded to the nearest integer to obtain the optimal integer solution.

Experiments with a Global Positioning System receiver have shown a gain of 4 dB and more from using Vector Tracking (VT) of the present invention and about 7 dB from using 10-bit Multibit optimization (MBit) as disclosed above. A combined gain of about 10 dB was obtained when both VT and Mbit were implemented.

The words “including,” “comprising,” “having,” and “with” as used herein are to be interpreted broadly. Moreover, any embodiments disclosed herein must not be taken as the only possible embodiments. Other embodiments will occur to those skilled in the art and are within the scope of the claims herein.

We claim:

1. A GPS receiver for tracking GPS signals comprising:
an antenna for receiving GPS signals;
a RF front end for down-converting the received GPS signals;
an analog to digital converter for digitizing the down-converted GPS signals; and
a navigation filter configured to obtain the navigation filter state data using the digitized GPS signals and to update said navigation filter state data with pseudorange and residual Doppler measurements from carrier and code correlators for GPS carrier and code tracking.

2. The GPS receiver of claim 1, wherein GPS carrier and code tracking includes vector tracking of the GPS signals.

3. The GPS receiver of claim 2, wherein vector tracking includes formation of the carrier and code Digital Controlled Oscillator (DCO) commands.

4. The GPS receiver of claim 3, wherein formation of the DCO commands includes use of updated navigation filter state data, satellite ephemeris data, and the outputs of the carrier and code tracking loop filters.

5. The GPS receiver of claim 2, wherein vector tracking uses the updated navigation filter state and satellite ephemeris data to estimate and remove the dynamic stress estimates from the carrier and code tracking loops.

6. The GPS receiver of claim 1, wherein carrier tracking includes a carrier frequency locked loop.

7. The GPS receiver of claim 1, wherein carrier tracking includes a carrier phase locked loop.

8. The GPS receiver of claim 1, wherein code tracking includes a code phase locked loop.

9. The GPS receiver of claim 1, wherein the navigation filter is a Kalman Filter.

10. The GPS receiver of claim 1, wherein the navigation filter is an Extended Kalman Filter (EKF).

11. The GPS receiver of claim 1, wherein the navigation filter includes Probabilistic Data Association.

12. The GPS receiver of claim 1, wherein the code tracking includes use of at least three correlators.

13. The GPS receiver of claim 12, wherein each correlator processes signals from a different code tracking channel.

14. The GPS receiver of claim 12, wherein the correlator outputs are weighted using adaptive Kalman filtering.

15. The GPS receiver of claim 1, wherein the data bit modulation of the digitized GPS signals is estimated and removed.

16. The GPS receiver of claim 15, wherein the estimation and removal of the data bit modulation includes multibit processing.

17. The GPS receiver of claim 15, wherein the estimation and removal of the data bit modulation is achieved without external aiding.

18. The GPS receiver of claim 2, wherein the data bit modulation of the digitized GPS signals is estimated and removed.

19. The GPS receiver of claim 18, wherein the estimation and removal of the data bit modulation includes multibit processing.

20. The GPS receiver of claim 18, wherein the estimation and removal of the data bit modulation is achieved without external aiding.

21. A GPS receiver for tracking GPS signals comprising:
an antenna for receiving GPS signals;
a RF front end for down-converting the received GPS signals;
an analog to digital converter for digitizing the down-converted GPS signals;
a multibit optimizer for enhancing the signal-to-noise ratio of the digitized signals; and
a navigation filter configured to obtain navigation filter state data using the multibit optimized GPS signals for GPS carrier and code tracking.

22. The GPS receiver of claim 21, wherein GPS carrier and code tracking includes vector tracking of the GPS signals.

23. The GPS receiver of claim 22, wherein vector tracking includes formation of the carrier and code Digital Controlled Oscillator (DCO) commands.

24. The GPS receiver of claim 23, wherein the formation of the DCO commands includes use of updated navigation filter state data, satellite ephemeris data, and the outputs of the carrier and code tracking loop filters.

25. The GPS receiver of claim 22, wherein vector tracking uses the navigation filter state data and satellite ephemeris data to estimate and remove the dynamic stress estimates from the carrier and code tracking loops.

26. The GPS receiver of claim 21, wherein carrier tracking includes a carrier frequency locked loop.

27. The GPS receiver of claim 21, wherein carrier tracking includes a carrier phase locked loop.

28. The GPS receiver of claim 21, wherein code tracking includes a code phase locked loop.

29. The GPS receiver of claim 21, wherein the navigation filter is a Kalman Filter.

30. The GPS receiver of claim 21, wherein the navigation filter is an Extended Kalman Filter (EKF).

31. The GPS receiver of claim 21, wherein the navigation filter uses Probabilistic Data Association.

32. The GPS receiver of claim 21, wherein the navigation filter state data are updated using pseudorange and residual Doppler measurements.

33. The GPS receiver of claim 21, wherein the code tracking includes use of at least three correlators.

34. The GPS receiver of claim 33, wherein each correlator processes signals from a different code tracking channel.

35. The GPS receiver of claim 33, wherein the correlator outputs are weighted using adaptive Kalman filtering.

36. The GPS receiver of claim 21, wherein enhancing the signal-to-noise ratio includes estimation and removal of the data bit modulation from the digitized GPS signals.

37. The GPS receiver of claim 36, wherein estimation and removal of the data bit modulation includes multibit processing.

38. The GPS receiver of claim 36, wherein the estimation and removal of the data bit modulation is performed without external aiding.

39. The GPS receiver of claim 22, wherein enhancing the signal-to-noise ratio includes estimation and removal of the data bit modulation from the digitized GPS signals.

40. The GPS receiver of claim 39, wherein estimation and removal of the data bit modulation includes multibit processing.

41. The GPS receiver of claim 39, wherein the estimation and removal of the data bit modulation is performed without external aiding.

42. A GPS receiver for tracking GPS signals comprising:
an antenna for receiving GPS signals;
a RF front end for down-converting the received GPS signals;
an analog to digital converter for digitizing the down-converted GPS signals;
a multibit optimizer for enhancing the signal-to-noise (SNR) ratio of the digitized signals;
a navigation filter for obtaining the navigation filter state data using the SNR-enhanced GPS signals and updating said filter state data with pseudorange and residual Doppler measurements for GPS carrier and code tracking.

43. The GPS receiver of claim 42, wherein GPS carrier and code tracking includes vector tracking of the GPS signals.

44. The GPS receiver of claim 43, wherein vector tracking includes formation of the carrier and code Digital Controlled Oscillator (DCO) commands.

45. The GPS receiver of claim 44, wherein the formation of the carrier and code DCO commands includes using updated navigation filter state data, satellite ephemeris data, and the outputs of the carrier and code tracking loop filters.

46. The GPS receiver of claim 42, wherein carrier tracking includes a carrier frequency locked loop.

47. The GPS receiver of claim 42, wherein carrier tracking includes a carrier phase locked loop.

48. The GPS receiver of claim 42, wherein code tracking includes a code phase locked loop.

49. The GPS receiver of claim 42, wherein the navigation filter is a Kalman Filter.

50. The GPS receiver of claim 42, wherein the navigation filter is an Extended Kalman Filter (EKF).

51. The GPS receiver of claim 42, wherein the navigation filter further includes Probabilistic Data Association.

52. The GPS receiver of claim 43, wherein vector tracking uses the updated navigation filter state and satellite ephemeris data to estimate and remove the dynamic stress estimates from the carrier and code tracking loops.

53. The GPS receiver of claim 42, wherein enhancing the signal-to-noise ratio includes estimation and removal of the data bit modulation of the digitized GPS signals.

54. The GPS receiver of claim 53, wherein estimation and removal of the data bit modulation includes multibit processing.

55. The GPS receiver of claim 53, wherein the estimation and removal of the data bit modulation is performed without external aiding.

56. The GPS receiver of claim 43, wherein enhancing the signal-to-noise ratio includes estimation and removal of the data bit modulation of the digitized GPS signals.

57. The GPS receiver of claim 56, wherein estimation and removal of the data bit modulation includes multibit processing.

58. The GPS receiver of claim 56, wherein the estimation and removal of the data bit modulation is performed without external aiding.

59. A method for tracking GPS signals comprising the steps of:
receiving GPS signals;
down-converting the received GPS signals;
digitizing the down-converted GPS signals;
processing the digitized GPS signals in a navigation filter and determining the navigation filter state data;
updating the navigation filter state data with pseudorange and residual Doppler measurements from carrier and code correlators; and
providing the updated navigation filter state data, satellite ephemeris data, and the outputs of the carrier and code tracking loop filters for forming Digital Controlled Oscillator (DCO) commands for GPS signal carrier and code tracking.

60. The method of claim 59, wherein GPS signal carrier and code tracking includes vector tracking of the GPS signals.

61. The method of claim 60, wherein vector tracking uses the updated navigation filter state and satellite ephemeris data to estimate and remove the dynamic stress estimates from the carrier and code tracking loops.

62. The method of claim 59, wherein carrier tracking includes a carrier frequency locked loop.

63. The method of claim 59, wherein carrier tracking includes a carrier phase locked loop.

64. The method of claim 59, wherein code tracking includes a code phase locked loop.

65. The method of claim 59, wherein the navigation filter is a Kalman Filter.

66. The method of claim 59, wherein the navigation filter is an Extended Kalman Filter (EKF).

67. The method of claim 59, wherein the navigation filter includes Probabilistic Data Association.

68. The method of claim 59, wherein the code tracking includes use of at least three correlators.

69. The method of claim 68, wherein each correlator processes signals from a different code tracking channel.

70. The method of claim 69, wherein the correlator outputs are weighted using adaptive Kalman filtering.

71. The method of claim 59, wherein the data bit modulation of the digitized GPS signals is estimated and removed.

72. The method of claim 71, wherein the data bit modulation of the digitized GPS signals is estimated and removed using multibit processing.

73. The method of claim 71, wherein the estimation and removal of the data bit modulation is achieved without external aiding.

74. The method of claim 60, wherein the data bit modulation of the digitized GPS signals is estimated and removed.

75. The method of claim 74, wherein the data bit modulation of the digitized GPS signals is estimated and removed using multibit processing.

76. The method of claim 74, wherein the estimation and removal of the data bit modulation is achieved without external aiding.

77. A method for tracking low signal-to-noise GPS signals comprising the steps of:
receiving GPS signals;
down-converting the received GPS signals;
digitizing the down-converted GPS signals;
enhancing the signal-to-noise (SNR) ratio of the digitized GPS signals;
using the SNR-enhanced digitized GPS signals with a navigation filter employing probabilistic data association to determine the navigation filter state data; and
updating the navigation filter state data with pseudorange and residual Doppler measurements for GPS signal carrier and code tracking.

78. The method of claim 77, wherein GPS carrier and code tracking includes vector tracking of the GPS signals.

79. The method of claim 78, wherein vector tracking includes formation of the carrier and code Digital Controlled Oscillator (DCO) commands.

80. The method of claim 79, wherein formation of the DCO commands includes use of the navigation filter state data, satellite ephemeris data, and the outputs of the carrier and code tracking loop filters.

81. The method of claim 78, wherein vector tracking uses the navigation filter state and satellite ephemeris data to estimate and remove the dynamic stress estimates from the carrier and code tracking loops.

82. The method of claim 77, wherein carrier tracking includes a carrier frequency locked loop.

83. The method of claim 77, wherein carrier tracking includes a carrier phase locked loop.

84. The method of claim 77, wherein code tracking includes a code phase locked loop.

85. The method of claim 77, wherein the navigation filter is a Kalman Filter.

86. The method of claim 77, wherein the navigation filter is an Extended Kalman Filter (EKF).

87. The method of claim 77, wherein the code tracking includes use of at least three correlators.

88. The method of claim 87, wherein each correlator processes signals from a different code tracking channel.

89. The method of claim 87, wherein the correlator outputs are weighted using adaptive Kalman filtering.

90. The method of claim 77, wherein enhancing the signal-to-noise ratio includes estimation and removal of the data bit modulation from the digitized GPS signals.

91. The method of claim 90, wherein the data bit modulation of the digitized GPS signals is estimated and removed using multibit processing.

92. The method of claim 90, wherein the estimation and removal of the data bit modulation is achieved without external aiding.

93. The method of claim 78, wherein enhancing the signal-to-noise ratio includes estimation and removal of the data bit modulation from the digitized GPS signals.

94. The method of claim 93, wherein the data bit modulation of the digitized GPS signals is estimated and removed using multibit processing.

95. The method of claim 93, wherein the estimation and removal of the data bit modulation is achieved without external aiding.

96. The method of claim 78, wherein the code tracking includes use of at least three correlators.

97. The method of claim 96, wherein each correlator processes signals from a different code tracking channel.

98. The method of claim 78, wherein the correlator outputs are weighted using adaptive Kalman filtering.
